(19) United States
(12) Patent Application Publication
(10) Pub. No.: US 2026/0242278 A1
(43) Pub. Date: Aug. 20, 2026

(54) COMPOSITE FILMS FOR MOBILE ELECTRONIC DEVICE COMPONENTS

(71) Applicant: SYENSQO SPECIALTY POLYMERS USA, LLC, Alpharetta, GA (US)

(72) Inventors: Nan Chen, Cumming, GA (US); Christine McGuiness, Alpharetta, GA (US); Mattia Bassi, Milano (IT); Liubov Chernysheva, Milano (IT)

(73) Assignee: SYENSQO SPECIALTY POLYMERS USA, LLC, Alpharetta, GA (US)

(21) Appl. No.: 19/161,207

(22) PCT Filed: Jan. 31, 2024
(86) PCT No.: PCT/EP2024/052299

§ 371 Date: Aug. 29, 2025

Related U.S. Application Data
(60) Provisional application No. 63/483,614, filed on Feb. 7, 2023.

(30) Foreign Application Priority Data
Mar. 6, 2023 (EP) 23160088.3

(51) Int. Cl. C03C 25/28; D06M 15/256

(52) U.S. Cl. CPC C03C 25/28; D06M 15/256

(57) ABSTRACT

A composite film (CF) has a thickness of less than 0.10 mm and includes: a glass or quartz fiber fabric (FF); a composition comprising at least one fluoropolymer (FP) coated on the surface of the fiber fabric (FF); wherein fluoropolymer (FP) comprises: recurring units derived from tetrafluoroethylene (R_{TFE}); recurring units (R_{F}) derived from perfluoro(alkyl vinyl ether)s (PAVE), hexafluoropropylene (HFP) and combinations thereof; recurring units (R_{M}) derived from at least one monomer (M) selected from the group consisting of (i) monomers comprising a functional group (FG) selected from: an hydroxy group, an isocyanate group, a carboxylic acid group and an anhydride group, (ii) chlorotrifluoroethylene (CTFE) and (iii) dichlorodifluoroethylene (R1112); with the following proportions expressed in mol % based on the total amount of moles of recurring units of the fluoropolymer (FP): (R_{TFE}): at least 75.0 mol %; (R_{F}): between 0 and 20.0 mol %; and (R_{M}): between 0.01 to 5.0 mol %.

This application claims priority of U.S. provisional 63/483,614 filed on 7 Feb. 2023 and EP Application Serial No. 23160088.3 filed on 6 Mar. 2023, the content of which being entirely incorporated herein by reference for all purposes. In case of any incoherency between this application and one of the previous applications that would affect the clarity of a term or expression, it should be made reference to this application only.

### TECHNICAL FIELD

The present disclosure relates to a flexible composite film (CF) well-suited for the preparation of a copper clad laminate (CCL), the composite film (CF) being based on the combination of at least one fluoropolymer (FP), and at least one woven fiber fabric (FF) and exhibiting a good flexibility and a good resistance to folding.

### BACKGROUND

Due to their reduced weight and high mechanical performance, polymer compositions are widely used to manufacture mobile electronic device components. There is now a high demand from the market for polymer compositions to be used to manufacture mobile electronic device components having improved dielectric performances (i.e. low dielectric constants and dissipation factor).

In mobile electronic devices, the material forming the various components and housing can significantly degrade wireless radio signals (e.g. 1 MHz, 2.4 GHz and 5.0 GHz frequencies) which are transmitted and received by the mobile electronic device through one or more antennas. The dielectric performances of the material to be used in mobile electronic devices can be determined by measuring the dielectric constant and the dissipation factor. They represent the ability of the material to interact with the electromagnetic radiation and disrupt electromagnetic signals (e.g. radio signals) travelling through the material. Accordingly, the lower the dielectric constant of a material at a given frequency, the less the material disrupts the electromagnetic signal at that frequency.

Polymer films are employed in the domain of mobile electronic devices. For example, aromatic polyimide films in the form of a continuous aromatic polyimide film/copper foil laminate structure have been described for manufacturing flexible printed circuit boards (FPC), carrier tapes for tape-automated-bonding (TAB), and tapes of lead-on-chip (LOC) structure. Such films are presented as showing good high temperature resistance, good chemical properties, high electrical insulating property and high mechanical strength. However, polyimide films do not show the expected dielectric performances, especially the dissipation factor of polyimide films is too high to be used in applications at high frequency (≥20 GHZ). In addition, the dissipation factor at high frequency of polyimide films gets even worse under a humid environment, due to the moisture absorption.

U.S. Pat. No. 8,741,790 relates to a PTFE/fiberglass composites useful as conveyor belts. Conveyor belts made from PTFE resins are used in many various applications. Because many of the applications rely on heat being transferred through the belts, belt thicknesses are preferably kept to a minimum. As described in the document thicknesses typically range from as low as 5 mils (i.e. 0.127 mm) to possibly as high as 20 mils (i.e. 0.508 mm).

WO 2022/259981 discloses a composition having improved adhesion on metal based on a fluorine-containing polymer having a functional monomer and an inorganic filler that has a specific surface area of less than 5.5 m²/g.

WO 2023/005311 discloses a laminate article comprising a dielectric substrate comprising a perfluorocopolymer matrix comprising a fluorinated perfluorocopolymer and a non-fluorinated perfluorocopolymer; a quartz fabric embedded in the perfluorocopolymer matrix and an additive material dispersed in the matrix, where the additive is capable of absorbing ultraviolet light. The perfluorocopolymer is different from the one used in the present invention.

WO 2022/158524 (D1) discloses a laminate comprising a copper foil layer, a fluororesin film and a substrate layer. The laminate has a fabric layer made of glass fiber and a resin film layer. D1 also discloses that the fabric layer made of glass fiber is a glass cloth or a glass non-woven fabric. D1 discloses that the fluoropolymer may include at least one functional group based on a carbonyl group in the fluororesin. The functional group can be an acid anhydride, a carbonate group, a haloformyl group, . . . . Moreover, D1 discloses that the functional group can be derived from a monomer, a chain transfer agent and a polymerization initiator. D1 does not mention the proportion of 0.01 to 5.0 mol % of recurring units (RM). The description of D1 thus does not disclose the composite film (CF) of the invention as this would result from a multiple-selection from D1. In addition, none of the examples of D1 disclose a composite film as defined in claim 1.

US 2008/107866 (D2) discloses a laminate for a flexible printed wiring board having a three-layer laminated structure where a reinforcing layer (A), an electrical insulator layer (B) and an electrical conductor layer (C) are laminated in this order, wherein the electrical insulator layer (B) is made of a fluorocopolymer comprising repeating units (a) based on tetrafluoroethylene and/or chlorotrifluoroethylene, repeating units (b) based on a fluoromonomer excluding tetrafluoroethylene and chlorotrifluoroethylene, and repeating units (c) based on a monomer having an acid anhydride residue and a polymerizable unsaturated bond in amounts of (a) being from 50 to 99.89 mol %, (b) being from 0.1 to 49.99 mol % and (c) being from 0.01 to 5 mol %, is based on ((a)+(b)+(c)). The reinforcing layer (A) is made of at least one member selected from the group consisting of a polyimide resin, a polyether ether ketone resin, a polyphenylene, oxide resin, a LCP resin, an aramide fiber woven fabric, an aramide fiber non-woven fabric, an aramide paper, a glass cloth and a PTFE porous material. D2 does not disclose a composite film (CF) with the same features as in claim 1 and with a thickness less than 0.20 mm. D2 also does not disclose the preferred configuration (ii) of the composite film.

U.S. Pat. No. 7,687,142 (D3) discloses a laminate for a printed wiring board having a laminate structure comprising an electrical insulator layer (A) and an electrical conductor layer (B) bonded directly to each other. D3 does not disclose a thickness lower than 0.20 mm.

### Technical Problem

With the development of 5G equipment, there is a requirement for a CCL exhibiting low dielectric properties, even in humid conditions, and including a polymeric protective layer exhibiting a good chemical resistance, a good durability and a strong adhesion on the copper foil. Moreover, there is a demand for a CCL and a protective layer exhibiting a good flexibility and a good resistance to folding.

The composite film and the CCL of the invention aim at solving this technical problem.

### SUMMARY OF THE INVENTION

The invention is set out in the appended set of claims.

Thus, the invention relates to a composite film as defined in any one of claims 1-30.

The invention also relates to the use of the composite film as defined in claim 31.

The invention also relates to a copper-clad laminate as defined in any one of claims 32-35.

These subject-matters are now defined in more detail below.

### FIGURES

FIG. 1 illustrates in a schematic way the preferred configuration (ii) of the composite film (CF) of the invention or as defined in the claims in combination with claim 2.

FIG. 2 illustrates also the preferred configuration (ii) of the composite film (CF) of the invention. On this figure, the warp (f1) or the weft fibers (f2) are oriented at angle α=0° relative to the longitudinal axis of the composite film (CF).

FIG. 3 illustrates also the preferred configuration (ii) of the composite film (CF) of the invention. On this figure, the warp (f1) or the weft fibers (f2) are oriented at angle α=45° relative to the longitudinal axis of the composite film (CF).

On these figure, (1) and (3) are the layers of the composition (C) and (2) is the fiber fabric (FF). (4) designates the longitudinal axis of the composite film (CF).

### Definitions

Unless otherwise stated, these definitions apply to the whole content of the present disclosure.

wt. % is a percentage by weight. Mol. % is a percentage by mole.

Unless otherwise stated, the proportions of recurring units in the polymers are given in mol % and relative to the total proportion of recurring units in the polymer.

When numerical ranges are given herein, unless otherwise indicated, the end-points of the ranges (even the open-ended ranges such as those comprising “at least”, “at most”, “lower than”, “higher than”, etc) are included.

In the present application, unless otherwise indicated, any specific embodiment or technical feature relating to one of the subject-matters of the invention is applicable to and interchangeable with another embodiment or technical feature relating also to said subject matter and disclosed elsewhere in the application, notably in the set of claims.

The recurring units derived from a given monomer X are designated by the following nomenclature (Rx). For instance, (R_{TFE}) stands for recurring units derived from TFE.

### DISCLOSURE OF THE INVENTION

The present invention relates to a composite film (CF) having a thickness (T) of less than 0.20 mm, preferably less than 0.15 mm, preferably less than 0.10 mm, and comprising:
a fiber fabric (FF) selected in the group of glass or quartz fiber fabric;
a composition (C) comprising at least one fluoropolymer (FP) in contact with at least one surface of the fiber fabric (FF);
wherein the fiber fabric (FF) is woven and wherein the fluoropolymer (FP) comprises:
   recurring units derived from tetrafluoroethylene (R_{TFE});
   recurring units (R_{F}) derived from a fluoromonomer (F) selected in the group of perfluoro (alkyl vinyl ether) s (PAVE), hexafluoropropylene (HFP) and combination of two of more of said monomers;
   recurring units (R_{M}) derived from at least one monomer (M) selected in the group consisting of (i) monomers comprising a functional group (FG) selected in the group consisting of an hydroxy group, an isocyanate group, a carboxylic acid group and an anhydride group, (ii) chlorotrifluoroethylene (CTFE) and (iii) dichlorodifluoroethylene (R1112);
with the following proportions expressed in mol %:
   (R_{TFE}): at least 75.0 mol %;
   (R_{F}): between 0 and 20.0 mol %;
   (R_{M}): between 0.01 and 5.0 mol %;
these proportions in mol % being based on the total amount of moles of recurring units of the fluoropolymer (FP).

The composite film (CF) preferably comprises only one fiber fabric (FF). This ensures a better foldability.

The composite film (CF) may be according to the two following configurations:
(i) configuration=composition (C)/fiber fabric (FF); or
(ii) configuration=composition (C)/fiber fabric (FF)/composition (C).

Under configuration (i), the composition (C) is in contact with only one side of the fiber fabric.

### Configuration (ii) of the Composite Film (CF)

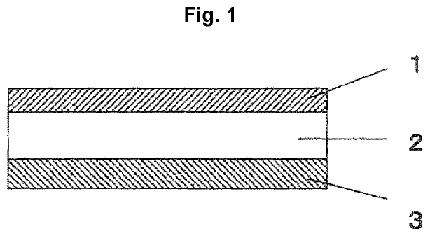

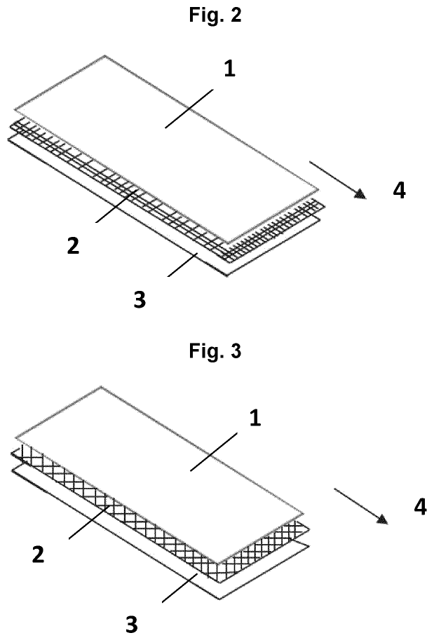

Under configuration (ii), the composition (C) is in contact with the two surfaces (or sides) of the fiber fabric (FF). FIGS. 1, 2 and 3 illustrate configuration (ii).

The present invention also relates to a composite film (CF) having a thickness (T) of less than 0.20 mm, preferably less than 0.15 mm, preferably less than 0.10 mm, and comprising or consisting of in that order:
a layer (L1) of composition (C);
a fiber fabric (FF) selected in the group of glass fiber fabric or quartz fiber fabric;
a layer (L2) of composition (C);
wherein composition (C) comprises at least one fluoropolymer (FP) in contact with at least one surface of the fiber fabric (FF);
wherein the fiber fabric (FF) is woven and wherein the fluoropolymer (FP) comprises:
   recurring units derived from tetrafluoroethylene (R_{TFE});
   recurring units (R_{F}) derived from a fluoromonomer (F) selected in the group of perfluoro (alkyl vinyl ether) s (PAVE), hexafluoropropylene (HFP) and combination of two of more of said monomers;
   recurring units (R_{M}) derived from at least one monomer (M) selected in the group consisting of (i) monomers comprising a functional group (FG) selected in the group consisting of an hydroxy group, an isocyanate group, a carboxylic acid group and an anhydride group, (ii) chlorotrifluoroethylene (CTFE) and (iii) dichlorodifluoroethylene (R1112);
with the following proportions expressed in mol %:
   (R_{TFE}): at least 75.0 mol %;
   (R_{F}): between 0 and 20.0 mol %;
   (R_{M}): between 0.01 and 5.0 mol %;
these proportions in mol % being based on the total amount of moles of recurring units of the fluoropolymer (FP).

If composite film (CF) comprises two layers of composition (C), these two layers are preferably based on the same fluoropolymer (FP), preferably they are of the same composition.

Details about the composition (C), the fluoropolymer (FP), the woven fiber fabric (FF) and the composite film (CF) are now given below.

### About the Fluoropolymer (FP)

The fluoropolymer (FP) comprises recurring units (R_{TFE}); recurring units (R_{F}) and recurring units (R_{M}) with the following proportions expressed in mol %:
(R_{TFE}): at least 75.0 mol %;
(R_{F}): between 0 and 20.0 mol %;
(R_{M}): between 0.01 and 5.0 mol %.

The proportion of recurring units (R_{F}) is between 0 and 20.0 mol %. This proportion may more particularly be between 0.1 and 20.0 mol %, more particularly between 0.1 and 10.0 mol %, even more particularly between 0.5 and 5.0 mol %. This proportion may also be between 1.0 and 5.0 mol % or 1.0 and 3.0 mol %.

The proportion of recurring units (R_{M}) may more particularly be between 0.05 and 5.0 mol %. This proportion may more particularly be between 0.05 and 3.0 mol % or between. This proportion is preferably at least 0.08. This proportion is preferably at most 1.5 mol % or at most 1.0 mol %.

According to an embodiment, the proportion of recurring units (R_{TFE}) corresponds to the remainder of the proportion of recurring units (R_{F}) and (R_{M}). In other words, proportion of (R_{TFE})=100%−(R_{F})−(R_{M}).

The proportion of recurring units (R_{TFE}) is at least 75.0 mol %. This ensures thermal resistance and adequate dielectric properties (Dₖ, D_{f}) of the fluoropolymer (FP). This proportion is therefore preferably at least 85.0 mol %, preferably at least 94.0 mol %.

The fluoromonomer (F) is selected in the group of perfluoro (alkyl vinyl ether)s (PAVE), hexafluoropropylene (HFP) and combination of two of more of said monomers.

The fluoromonomer (F) is preferably selected in the group of perfluoro (alkyl vinyl ether) s (PAVE). A PAVE is a monomer of generic formula CF₂═CFOR_{f} (I) wherein R_{f} is a C₁-C₈ perfluoroalkyl group, preferably a C₁-C₃ perfluoroalkyl group. The perfluoroalkyl group may be linear or branched.

In the context of the present disclosure, a PAVE may more particularly be selected in the group consisting of CF₂═CFOCF₃ (or PMVE), CF₂═CFOCF₂CF₃ (or PEVE), CF₂═CFOCF₂CF₂CF₃ (or PPVE), CF₂═CFOCF₂CF₂CF₂CF₃, CF₂═CFO(CF₂)₇CF₃ and combination of two or more of said monomers. In the context of the present disclosure, a PAVE may more particularly be selected in the group consisting of CF₂═CFOCF₃ (or PMVE), CF₂═CFOCF₂CF₃ (or PEVE), CF₂═CFOCF₂CF₂CF₃ (or PPVE) and combination of two or more of said monomers. In the context of the present disclosure, a PAVE is more particularly PPVE or PMVE.

Monomer (M) can comprise an hydroxy group as a functional group (FG). Monomer (M) can be for instance 2-hydroxyethyl (meth)acrylate, 2-hydroxyethyl crotonate, allyl alcohol.

Monomer (M) can comprise an epoxy group as a functional group (FG). Monomer (M) can be for instance allyl glycidyl ether, 2-methyl allyl glycidyl ether, vinyl glycidyl ether, glycidyl (meth)acrylate.

Monomer (M) can comprise an isocyanate group as a functional group (FG). Monomer (M) can be for instance 2-(meth)acryloyloxyethyl isocyanate, 2-(2-(meth)acryloyloxyethoxy)ethyl isocyanate, 1,1-bis((meth)acryloyloxymethyl)ethyl isocyanate.

Monomer (M) can comprise a carboxylic acid group as a functional group (FG). Monomer (M) can be for instance acrylic acid or methacrylic acid.

Monomer (M) is preferably a monomer comprising an anhydride group as a functional group (FG). Monomer (M) can be for instance itaconic anhydride, citraconic anhydride and 5-norbornene-2,3-dicarboxylic anhydride (NAH) of formula:

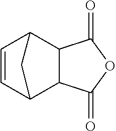 [SMILES: O=C1OC(=O)C2C3C=CC(C3)C12]

Monomer (M) may notably be selected in the group consisting of CTFE, R1112, itaconic anhydride, citraconic anhydride and 5-norbornene-2,3-dicarboxylic anhydride (NAH). Monomer (M) may also notably be selected in the group consisting of CTFE, R1112, NAH and combination of two of more of said monomers.

Monomer (M) can be NAH.

Monomer (M) can be CTFE.

Monomer (M) can be R1112. To note, dichlorodifluoroethylene may exist in 3 different isomers, cis-1,2-dichloro-1,2-difluoro-ethylene, trans-1,2-dichloro-1,2-difluoro-ethylene, and 1,1-difluoro-2,2-dichloro-ethylene. All isomers individually and mixtures thereof are suitable for the present invention, and the abbreviation R1112 herein used herein intends to encompass all individual isomers and also mixtures thereof. However, the 1,2-dichloro-1,2-difluoro isomers are preferred, individually or as a mixture.

Monomer (M) can also be a combination of CTFE and R1112.

### Embodiment (E1)

According to an embodiment (E1) of the present disclosure, the fluoropolymer (FP) comprises recurring units (R_{TFE}) derived from TFE, recurring units (R_{F}) derived from at least one PAVE as disclosed herein and recurring units (R_{M}) derived from a monomer (M) comprising an anhydride group, (M) being preferably NAH, the proportions of those recurring units being as disclosed herein. More particularly, the fluoropolymer (FP) of this embodiment (E1) comprises recurring units from TFE, PPVE and a monomer (M) comprising an anhydride group, preferably NAH, the proportions of those recurring units being as disclosed herein.

A specific fluoropolymer (FP) according to this embodiment (E1) comprises recurring units from TFE, at least one PAVE and at least one monomer (M) comprising an anhydride group, (M) being preferably NAH, with the following proportions:
(R_{TFE}): at least 95.5 mol %;
(R_{PAVE}): between 1.0 and 3.0 mol %;
(R_{M}): between 0.08 and 1.5 mol %, preferably between 0.08 and 1.0 mol %.

A specific fluoropolymer (FP) according to this embodiment (E1) comprises recurring units from TFE, at least one PAVE and NAH with the following proportions:
(R_{TFE}): at least 95.5 mol %;
(R_{PAVE}): between 1.0 and 3.0 mol %;
(R_{NAH}): between 0.08 and 1.5 mol %, preferably between 0.08 and 1.0 mol %.

### Embodiment (E2)

According to another embodiment (E2) of the present disclosure, the fluoropolymer (FP) comprises recurring units (R_{TFE}) derived from TFE, optionally recurring units (R_{F}) derived from at least one PAVE as disclosed herein and recurring units (R_{M}) derived from CTFE or R1112 or a combination of CTFE and R1112, the proportions of those recurring units being as disclosed herein. A specific fluoropolymer (FP) according to this embodiment (E2) is fluoropolymer C1, C2 or C3 as disclosed in claim 1 of WO 2022/157099.

A specific fluoropolymer (FP) according to this embodiment (E2) comprises recurring units from TFE, from at least one PAVE and from CTFE with the following proportions:
(R_{TFE}): at least 82.0 mol %;
(R_{PAVE}): between 1.0 and 3.0 mol %;
(R_{CTFE}): between 0.01 and 5.0 mol %.

The proportions may also be the following ones:
(R_{TFE}): at least 82.0 mol %;
(R_{PAVE}): between 1.0 and 3.0 mol %;
(R_{CTFE}): between 0.08 and 1.5 mol %.

A specific fluoropolymer (FP) according to this embodiment (E2) comprises recurring units from TFE, optionally from at least one PAVE and from R1112 with the following proportions:
(R_{TFE}): at least 75.0 mol %;
(R_{PAVE}): between 0 and 20.0 mol %;
(R_{R1112}): between 0.01 and 5.0 mol %.

A specific fluoropolymer (FP) according to this embodiment (E2) comprises recurring units from TFE, optionally from at least one PAVE, from R1112 and from CTFE with the following proportions:
(R_{TFE}): at least 75.0 mol %;
(R_{PAVE}): between 0 and 20.0 mol %;
(R_{R1112}): between 0.01 and 5.0 mol %;
(R_{CTFE}): between 0.01 and 5.0 mol %;
with the proviso that the total proportion of recurring units (R_{R1112}) and (R_{CTFE}) does not exceed 5.0 mol %

In the context of the present disclosure, the recurring units of the fluoropolymer (FP) preferably consist essentially of or consist of the recurring units (R_{TFE}), (R_{F}) and (R_{M}). The expression “consist essentially” means in the context of the recurring units that recurring units of the fluoropolymer (FP) consist of the recurring units (R_{TFE}), (R_{F}), (R_{M}) and up to 1.5 mol %, preferably up to 1.0 mol %, preferably up to 0.5 mol % of recurring units other than (R_{TFE}), (R_{F}) and (R_{M}).

The fluoropolymer (FP) is prepared by a radical copolymerization of monomers tetrafluoroethylene (TFE), fluoromonomer(s) (F) and monomer(s) (M).

The polymerization is usually performed in an aqueous medium, either in suspension or in emulsion. The fluoropolymer (FP) can be prepared in aqueous polymerization medium, using emulsion and/or suspension polymerization techniques. The polymerization is initiated with the use of at least radical initiator. Surfactants such as fluorinated surfactants and/or non fluorinated surfactants are usually present in the aqueous medium to help stabilize the suspension or the emulsion. Chain transfer agents may also be used to control molecular weight and viscosity of the fluoropolymer (FP).

Typically the fluoropolymer (FP) is prepared by an emulsion polymerization technique and the resulting material is finely dispersed in an aqueous medium in the form of a latex. For subsequent processing, the fluoropolymer (FP) is extracted from the latex using known techniques (such as e.g. coagulation by freezing). The extracted polymer is washed with demineralized water and dried at high temperature (e.g. 150-160° C.) to remove the residual humidity.

The fluoropolymer (FP) may be prepared according to the conditions given in the description and in the examples of WO 2022/157099, in U.S. Pat. No. 5,760,151 or in US 2010/0036053 A1. The fluoropolymer (FP), notably the fluoropolymer with units of NAH, can be prepared according to WO 2016/017801, notably according to § [0123] of WO 2016/017801.

The melting temperature (Tm) of the fluoropolymer (FP) is preferably at least 280° C., more preferably at least 290° C. Tm is usually at most 320° C. Tm is usually measured according to ASTM D4591-22.

The melt flow rate (MFR) of the fluoropolymer (FP) measured according to ASTM D1238 (372° C.; 5 kg) is preferably at least 1.0 g/10 min. The MFR may advantageously be at least 8.0 g/10 min. The MFR may more particularly be between 8.0 and 20.0 g/10 min.

### About the Composition (C)

The composition (C) of the composite film (CF) comprises or consists of:
at least one fluoropolymer (FP);
optionally at least one fluoropolymer (FP*) other than the fluoropolymer (FP); and
optionally at least one additive selected in the group of fillers, pigments, colorants and additive materials capable of absorbing ultraviolet (UV) light having a wavelength of between 180 nm and 400 nm.

The composition (C) of the composite film (CF) may comprise or consist of:
at least one fluoropolymer (FP); and
optionally at least one additive selected in the group of fillers, pigments, colorants and additive materials capable of absorbing ultraviolet (UV) light having a wavelength of between 180 nm and 400 nm.

The components of composition (C) are typically blended so as to form an homogeneous mixture. This is typically accomplished by the use of an extruder in which the polymeric component(s) is/are in the molten form.

The composition (C) may comprise a fluoropolymer (FP*) other than the fluoropolymer (FP). Fluoropolymer (FP*) may be a copolymer comprising between 80.0 and 99.9 mol % of recurring units (R_{TFE}) and between 0.1 and 20.0 mol % of recurring units derived from at least one perfluoroalkylvinylether (PAVE) and not comprising recurring units (R_{M}). According to an embodiment, the recurring units of the fluoropolymer (FP*) consist of recurring units (R_{TFE}) and the recurring units derived from the at least one perfluoroalkylvinylether (PAVE) with the proportions indicated herein.

The composition (C) may comprise at least one filler. The filler is suitably selected in the group consisting of carbon nitride, boron nitride, boron carbide, boron phosphide, phosphorus nitride, boron carbonitride, carbon black, glass fiber, boron fiber, silica fiber, aramid fiber and mixtures thereof.

The composition (C) may comprise at least one additive material capable of absorbing ultraviolet (UV) light having a wavelength of between 180 nm and 400 nm. Such an additive enables the CCL to be drilled by a laser for formation of circuit structures.

The proportion of the additive(s) in the composition (C) is usually at most 5.0 wt %, this proportion being based on the total weight of the composition (C).

The proportion of the fluoropolymer(s) (FP) and the fluoropolymer(s) (FP*) (if any) in the composition (C) is at least 95.0 wt %, more particularly at least 99.0 wt %, this proportion being based on the weight of the composition (C).

The proportion of fluoropolymer(s) (FP) may be between 1.0 and 99.0 wt %, preferably between 10.0 and 60.0 wt %, this proportion being based on the total weight of the fluoropolymer(s) (FP) and the fluoropolymer(s) (FP*).

The proportion of fluoropolymer(s) (FP*) may be between 1.0 and 99.0 wt %, preferably between 10.0 and 60.0 wt %, this proportion being based on the total weight of the fluoropolymer(s) (FP) and the fluoropolymer(s) (FP*).

According to an embodiment, the composition comprises as polymeric component only the at least one fluoropolymer (FP) as disclosed herein. The polymeric component of composition (C) consists of the at least one fluoropolymer (FP).

According to an embodiment, it comprises as polymeric component only one fluoropolymer (FP) as disclosed herein. The polymeric component of composition (C) consists of only one fluoropolymer (FP).

### About the Fiber Fabric (FF)

The fiber fabric (FF) is woven and is selected in the group of glass or quartz fiber fabric. Woven fabrics are produced by the interlacing of warp fibers (f1) and weft fibers (f2) in a regular weave pattern, f1 and f2 being both made of either glass or quartz and being at 90°+2, preferably at 90°+1, to each other.

The fiber fabric (FF) is typically prepared on a weaving machine wherein the fibers are processed into the finished fiber fabric (or cloth).

The fiber fabric (FF) may more particularly be according to any one of the following weave patterns: plain weave, satin weave such as 4-Harness Satin, 5-Harness Satin and 8-Harness Satin or twill weave notably the 2×2 Twill Weave. The fiber fabric (FF) is generally plain weave.

The fiber fabric (FF) may for example present an average thickness of about 200 μm or less, for example of 180 μm or less or of 160 μm or less.

The fibers in the fiber fabric (FF) may present an average diameter of about 25 μm or less, for example of about 23 μm or less or of 21 μm or less.

In some embodiments, the fiber fabric (FF) is such that it has an average area weight (in grams per square meter or g/m²) comprised between 10 g/m² and 100 g/m², for example between 12 g/m² and 90 g/m² or between 15 g/m² and 80 g/m². The average area weight is preferably between 15.0 and 40.0 g/m².

In some embodiments, the fiber fabric (FF) is such that it has a thickness between 0.01 mm and 0.09 mm, even a thickness between 0.02 mm and 0.07 mm.

The fiber fabric (FF) is preferably characterised by low dielectric constant and low dissipation factor. The fiber fabric (FF) may be characterized by a dielectric constant Dₖ at 1 GHZ, measured using a transmission line method and a vector network analyzer, of less than 5.5 and/or a dissipation factor D_{f} at 1 GHz, measured using a transmission line method and a vector network analyzer, of less than 0.0030.

The fiber fabric (FF) preferably has a dielectric constant Dₖ at 1 GHZ, measured using a transmission line method and a vector network analyzer, of less than 5.0. The dielectric constant Dₖ at 1 GHZ, is generally not less than 3.0.

The fiber fabric (FF) preferably has a dissipation factor D_{f} at 1 GHZ, measured using a transmission line method and a vector network analyzer, of less than 0.0025, even less than 0.0020. The dissipation factor D_{f} at 1 GHz is generally not less than 0.0001.

Quartz fiber fabrics with the properties detailed above are available from Saint-Gobain under the trade name Quartzel® Veil. An example of a suitable quartz fiber fabric of this brand is made of a non-porous, ultra-pure silica fibers with a SiO₂ content equal to or greater than 99.95%, the fibers' diameter is 9-14 μm and the fiber's length >5 mm, the product has an average area weight (in grams per square meter or g/m²) of 25.

Glass fiber fabrics with the properties detailed above are available from Nittobo as well as from CTG Taishan Fiberglass. An example of suitable glass fiber fabric that may be used for the preparation of the composite film is LD1035-127 commercialized by CTG Taishan Fiberglass.

The glass fiber fabric (FF) may be made of fibers comprising at least 33.0 parts by mass to 48.0 parts by mass of silicon oxide; 1.0 parts by mass to 5.0 parts by mass of alumina; 5.0 parts by mass to 10.0 parts by mass of titanium oxide; 0.5 parts by mass to 4.0 parts by mass of zirconium oxide; and at least one of the following oxides holmium oxide, alkaline earth metal oxides, neodymium oxide, and iron oxide.

In certain embodiments, the glass fiber fabric (FF) is made of fibers having the following composition: silicon oxide, 35.0 parts by mass to 48.0 parts by mass; alumina, 1.0 parts by mass to 5.0 parts by mass; titanium oxide 5.5 parts by mass to 10.0 parts by mass; zirconium oxide, 0.5 parts by mass to 4.0 parts by mass; holmium oxide, less than or equal to 3.0 parts by mass; alkaline earth metal oxides, 32.0 parts by mass to 47.5 parts by mass, with respect to the total mass of the fiber. Alternatively, the glass fiber fabric is made of fibers having the following composition: silicon oxide, 33.0 parts by mass to 46.0 parts by mass; alumina, 1.5 parts by mass to 5.0 parts by mass; titanium oxide, 5.0 parts by mass to 10.0 parts by mass; zirconium oxide, 0.5 parts by mass to 4.0 parts by mass; neodymium oxide, less than or equal to 2.5 parts by mass; iron oxide, less than or equal to 1.2 parts by mass; alkaline earth metal oxide, 31.0 parts by mass to 53.0 parts by mass, with respect to the total mass of the fiber.

In certain embodiments, the glass fiber fabric (FF) is made of fibers having the following composition: 45.0-70.0 wt % SiO₂, 0-20.0 wt % Al₂O₃, 10.0-35.0 wt % B₂O₃, 88.0-98.0 wt % SiO₂+Al₂O₃+B₂O₃, 0-0.7 wt % Li₂O+Na₂O+K₂O, 0.1-12.0 wt %, 0-3.0 wt % TiO₂ and a mass ratio CaO/MgO of 1.0 or less.

### About the Composite Film (CF)

The composite film has a thickness (T) of less than 0.20 mm (≤0.20 mm), preferably less than 0.15 mm (≤0.15 mm), preferably less than 0.10 mm (≤0.10 mm). T is generally at least 0.01 mm (≥0.01 mm) or at least 0.02 mm (≥0.02 mm) or at least 0.03 mm (≥0.03 mm).

T may be comprised between 0.005 and 0.20 mm or between 0.005 and 0.10 mm, preferably between 0.010 and 0.09 mm. The thickness may be preferably between 0.02 and 0.08 or between 0.03 and 0.07 mm.

The composite film (CF) of the invention typically does not comprise an electrical conductor layer (e.g. copper layer or copper foil).

The composite film (CF) of the invention is typically in the form of a square or rectangular shape. The width w of the composite film (CF) of the invention is typically at least 250 mm. w is generally between 250 and 1500 mm.

Since composite film (CF) exhibits a high bendability, it can be in the form of a roll film.

The composite film (CF) of the invention is flexible and exhibits a good folding endurance. The MIT folding endurance test according to ASTM D2176-16 makes it possible to test the resistance of plastic films to repeated folding. This test provides the number of cycles before failure of the film tested.

The composite film (CF) of the invention typically exhibits a folding endurance equal to or greater than 40,000 cycles, preferably equal to or greater than 50,000 cycles. The folding endurance may preferably be at least 80,000 cycles. The measurement is performed according to ASTM D2176-16 at 90 cycles/min under a 0.9072 kg load, 135° angle and a temperature which is 23±2° C.

The composite film (CF) of the invention preferably exhibits a coefficient of thermal expansion (CTE), notably in MD or in TD, lower than or equal to 80 ppm/° C. (1 ppm=μm/(m.° C.)), the conditions for measuring CTE being given in the Experimental Section.

According to the present invention, the composite film (CF) preferably comprises less than 75.0 wt. % of fiber fabric (FF), preferably between 5.0 and 70.0 wt. % or between 10.0 and 60.0 wt. % of fiber fabric (FF) per unit area of the composite film (CF).

According to the present invention, the composite film (CF) is preferably such that its volume of fiber (V_{f}) is between 20.0 and 60.0 vol. %, for example between 25.0 and 55.0 vol. % or from 30.0 and 50.0 vol. %, wherein Vf is calculated according to the following equation:

$${V}_{f} = \frac{Volume of fiber}{Volume of fiber + Volume of polymer}$$

### Embodiment (E3)

According to a preferred embodiment (E3), the warp (f1) or the weft fibers (f2) of the fiber fabric (FF) are oriented at an angle α relative to the longitudinal axis of the composite film (CF), a being between 20° and 80°, preferably between 30° and 70°, preferably between 40° and 60°, preferably between 42° and 58° or between 44° and 46°.

As mentioned above, as f1 and f2 are oriented at substantially 90° to each other (in other words the angle between f1 and f2 is, this means that these fibers f2 are oriented at an angle β substantially equal to (90°−α) relative to the longitudinal axis of the composite film (CF).

Embodiment (E3) makes it possible to have an improved bending endurance both for the composite film (CF) alone or of the CCL obtained from said composite film.

All details end embodiments relating to the composition (C), fluoropolymer (FP) and composite film (CF) disclosed herein are applicable to embodiment (E3).

### Dielectric Properties of the Composite Film (CF)

The composite film (CF) of the present invention preferably exhibits some advantageous dielectric properties. In some embodiments, the composite film (CF) exhibits at least one of the following dielectric constants Dk at 5 GHz as measured by Split Post Dielectric Resonator (SPDR), IEC 61189-2-721:2015:

| | |
|---|---|
| after drying 1 h at 100° C. | equal to or less than 3.0, preferably less than |
| | 2.8, preferably less than 2.7, preferably less |
| | than 2.6, preferably less than 2.5, preferably |
| | less than 2.4 |

and/or

| | |
|---|---|
| after immersion in water | equal to or less than 3.0, preferably less than |
| for 24 hours | 2.8, preferably less than 2.7, preferably less |
| | than 2.6, preferably less than 2.5 |

and/or

| | |
|---|---|
| after leaving the film 1 | equal to or less than 3.0, preferably less than |
| day at room temperature | 2.8, preferably less than 2.7, preferably less |
| in an atmosphere with | than 2.6, preferably less than 2.5, preferably |
| 50% relative humidity | less than 2.4 |

In some embodiments, the composite film (CF) exhibits at least one of the following dissipation factors Df at 5 GHZ as measured by Split Post Dielectric Resonator (SPDR), IEC 61189-2-721:2015:

| | |
|---|---|
| after drying 1 h at 100° C. | equal to or less than 0.0020, preferably less |
| | than 0.0015, preferably less than 0.0013, |
| | preferably less than 0.0012, preferably less |
| | than 0.0011 |

and/or

| | |
|---|---|
| after immersion in water | equal to or less than 0.0020, preferably less |
| for 24 hours | than 0.0015, preferably less than 0.0013, |
| | preferably less than 0.0012, preferably less |
| | than 0.0011 |

and/or

| | |
|---|---|
| after leaving the film 1 | equal to or less than 0.0020, preferably less |
| day at room temperature | than 0.0015, preferably less than 0.0013, |
| in an atmosphere with | preferably less than 0.0012, preferably less |
| 50% relative humidity | than 0.0011 |

In some embodiments, the composite film (CF) exhibits at least one of the following dielectric constants Dk at 20 GHz as measured by Split Cylinder Resonator, IPC TM-650 2.5.5.13:

| | |
|---|---|
| after drying 1 h at 100° C. | equal to or less than 3.0, preferably less than |
| | 2.8, preferably less than 2.7, preferably less |
| | than 2.6, preferably less than 2.5, preferably |
| | less than 2.4 |

and/or

| | |
|---|---|
| after immersion in water | equal to or less than 3.0, preferably less than |
| for 24 hours | 2.8, preferably less than 2.7, preferably less |
| | than 2.6, preferably less than 2.5, preferably |
| | less than 2.4 |

and/or

| | |
|---|---|
| after leaving the film 1 | equal to or less than 3.0, preferably less than |
| day at room temperature | 2.8, preferably less than 2.7, preferably less |
| in an atmosphere with | than 2.6, preferably less than 2.5, preferably |
| 50% relative humidity | less than 2.4 |

In some embodiments, the composite film (CF) exhibits at least one of the following dissipation factors Df at 20 GHz as measured by Split Cylinder Resonator, IPC TM-650 2.5.5.13:

| | |
|---|---|
| after drying 1 h at 100° C. | equal to or less than 0.0030, preferably less |
| | than 0.0028, preferably less than 0.0025, |
| | preferably less than 0.0024 |

and/or

| | |
|---|---|
| after immersion in water | equal to or less than 0.0028, preferably less |
| for 24 hours | than 0.0026, preferably less than 0.0025, |
| | preferably less than 0.0023 |

and/or

| | |
|---|---|
| after leaving the film 1 | equal to or less than 0.0028, preferably less |
| day at room temperature | than 0.0026, preferably less than 0.0025, |
| in an atmosphere with | preferably less than 0.0023 |
| 50% relative humidity | |

In some embodiments, the composite film (CF) may have the following combination of dielectric properties:
a Dk 5 GHz of less than 2.6; and/or
a Df 5 GHz of less than 0.0015; and/or
a Dk 20 GHz of less than 2.6; and/or
a Df 20 GHz of less than 0.0030; and/or
a Dk 50 GHz of less than 3.0, even less than 2.8; and/or
a Df 50 GHz of less than 0.0040, even less than 0.0025; and/or
a Dk 77 GHz of less than 3.0, even less than 2.8; and/or
a Df 77 GHz of less than 0.0040, even less than 0.0025;
wherein the Dk is measured by Split Cylinder Resonator, IPC TM-650 2.5.5.13 after drying 1 h at 100° C. and the Df is measured by Split Post Dielectric Resonator (SPDR), IEC 61189-2-721:2015 after drying 1 h at 100° C.

### Method for Preparing the Composite Film (CF)

The composite film (CF) of the present invention is prepared by the method which comprises a) putting into contact the composition (C) comprising the fluoropolymer (FP) on the surface(s) of the fiber fabric (FF) and b) applying pressure and heat to the composite structure obtained after step a).

More particularly, the composite film (CF) of the present invention is prepared by the method which comprises the steps of a) putting into contact the composition (C) comprising the fluoropolymer (FP) on the fiber fabric (FF) and b) applying pressure P of at least 0.3 MPa and heating at a temperature T_{process} such that the composition (C) is in the molten form.

The molten form and the pressure make it possible to achieve an intimate contact and bonding of the composition (C) with the fiber fabric.

Composition (C) may be in the form of a powder. The powder usually exhibits a Dv₅₀ (median) comprised between 0.1 and 100 μm, preferably between 1 and 90 μm or between 5 and 80 μm. The Dv₅₀ of the powder can be measured by laser scattering in isopropanol (distribution in volume).

The composition (C) may also be in the form of a film prepared from the composition (C). The method more particularly comprises the following steps:
a) applying the polymer film of the composition (C) to at least one surface of a fiber fabric (FF);
b) bonding the polymer film to the fiber fabric (FF) at a pressure P of at least 0.3 MPa and/or at temperature T_{process}.

Temperature T_{process} is such that composition (C) is in the molten form. If composition (C) comprises only (FP) as a fluoropolymer, it is then usually sufficient that T_{process}≥Tm, wherein Tm is the melting temperature of the fluoropolymer (FP). If the composition comprises also at least one additional fluoropolymer (FP*), one needs to take into account also the melting temperature of (FP*). In this case, T_{process} is preferably above the highest of the melting temperatures of the fluoropolymers present in composition (C).

Preferably, step b) is performed at a pressure P of at least 0.4 MPa, at least 0.5 MPa. Preferably, T_{process} is such that T≥Tm+5° C.

T_{process} is generally such that 300° C.≤T≤400° C. T_{process} may be between 30° and 350° C.

The duration of step b) depends on the composition and on the temperature and pressure applied. The duration is generally between 1 minute and 60 minutes. The duration may be between 1 minute and 30 minute or between 1 minute and 15 minutes.

The amount of pressure and temperature applied depends upon the type of fluoropolymer (FP) employed and upon the fiber fabric employed and the physical and dimensional properties of each, along with the operational, physical and dimensional properties of the press.

The method and conditions of preparation of the composite film given in the Experimental Section may be used to prepare the composite film (CF) of the invention.

### End-Use Applications of the Composite Film (CF)

The invention also relates to the use of composite film (CF) as disclosed herein for the preparation of a copper-clad laminate (CCL). The invention also relates to the use of the composition or of the fluoropolymer (FP) for the preparation of a copper-clad laminate.

The invention also relates to a copper-clad laminate (CCL) comprising at least one copper foil and the composite film (CF) of the invention.

According to an embodiment, the CCL comprises one copper foil. According to this embodiment, the CCL is of the following configuration: copper foil/composite film (CF).

According to another embodiment, the CCL comprises two copper foils. According to this embodiment, the CCL is of the following type: copper foil/composite film (CF)/copper foil. With the composition film (CF) under configuration (ii), the CCL is then of the following type: in that order, copper foil/composition (C)/fiber fabric (FF)/composition (C)/copper foil.

According to an embodiment, the copper foil(s) is/are in direct contact with the composite film (CF).

According to another embodiment, an adhesive layer is present between the copper foil(s) and the composite film (CF). The function of the adhesive layer is to improve the bonding between the copper foil and the composite film (CF).

The CCL is obtained by i) putting into contact the copper foil(s) and the composite film (CF) of the invention and ii) may be obtained by laminating the composite film (CF) on the copper foil(s), the copper foil(s) having been optionally coated with a layer of adhesive. Typical conditions consist in putting in contact the surfaces and in applying a pressure of at least 0.3 MPa and a temperature T>Tm of the fluoropolymer (FP). T is usually at least 300° C.

If the composition comprises at least one additional fluoropolymer (FP*), one needs to take into account also the melting temperature of FP*. In this case, T is preferably above the highest of the melting temperatures of the fluoropolymers present in the composition.

The pressure and heating are applied for a duration sufficient to allow for the adhesion of the composite film (CF) to be strong enough. The duration may be between 1 and 30 minutes. The duration is preferably at least 5 minutes.

The conditions (pressure, temperature and duration of contact) given in the Experimental Section may be applied for the preparation of the CCL of the invention.

The surface of the copper foil on which is applied the composite film may be pretreated in order to increase the adhesion of the composite film or the adhesive layer, the pretreatment being selected in the group of flame treatment, mechanical abrasion and chemical treatment. An example of chemical pretreatment of a copper foil can be found in US 2023/0019067.

The CCL preferably exhibits a peel strength of at least 7.0 N/cm, preferably at least 10.0 N/cm, measured according to standardized test IPC-TM-650, number 2.4.9. This test was developed for the measurement of the peel strength of metallic clad laminates.

Other uses: the present invention also relates to the use of at least one composite film to prepare a mobile electronic device article or component, for example a flexible printed circuit board (FPC). The composite film of the present invention may notably be used to prepare flexible printed circuit boards (FPC), carrier tapes for tape-automated-bonding (TAB), and tapes of lead-on-chip (LOC) structure.

### EXPERIMENTAL SECTION

The disclosure will be now described in more detail with reference to the following examples, whose purpose is merely illustrative and not intended to limit the scope of the disclosure.

### Starting Materials

Fluoropolymer (FP-1); copolymer TFE (97.9 mol %)/PPVE (2.0 mol %)/NAH (0.1 mol %). Tm=300° C.; MFR=17.6 g/10 min (ASTM D1238 (372° C.; 5 kg)).

Fluoropolymer (FP-2): copolymer TFE (96.0 mol %)/PPVE (3.9 mol %)/CTFE 0.1 mol %. Tm=312° C.; MFR=15.0 g/10 min (ASTM D1238 (372° C.; 5 kg)).

Glass fabric (FF-1); glass fiber fabric LD1035-127, commercially available from CTG Taishan Fiberglass; dielectric Constant Dₖ @ 1 GHz of 4.3-4.5 and dissipation factor D_{f} @ 1 GHz of 0.0016, both Dₖ and D_{f} measured using a transmission line method and a vector network analyzer. LD1035-127 exhibits an average area weight of 26.2 gsm. Other characteristics: thread count warp 65 per 25 mm, fill 68 per 25 mm.

Quartz fabric (FF-2): quartz fiber fabric Quartzel® Veil commercially available from Saint-Gobain, average area weight (in grams per square meter gsm or g/m²) of 25.

Glass fabric (FF-3); glass fiber fabric NTB 1027 (plain weave), commercially available from Nittobo. NTB 1027 exhibits an average area weight of 18.0 gsm. Other characteristics: thickness: 0.020 mm; thread count warp 74.3 per 25 mm, weft 75.7 per 25 mm. The glass fibers are made of a glass which has a lower contents of alkaline earth metals (such as CaO and MgO) than general-purpose E glass which is generally used for composite materials and a higher content of boric acid (B₂O₃). This specific composition ensures that the fibers exhibit a low dielectric constant and low dielectric dissipation factor.

Glass fabric (FF-4): glass fiber fabric NTB 1017 (plain weave), commercially available from Nittobo. Same composition as FF-3. Other characteristics: thickness: 0.015 mm. Average area weight of 13.0 gsm. Thread count warp 95 per 25 mm, weft 95 per 25 mm.

All four glass fiber fabrics tested are woven.

Method of preparation of the composite films (CF): a fluoropolymer film (FP-1 or FP-2) was used to prepare the composite films (CF) in the following configuration: polymer (FP)/(fiber fabric)/polymer (FP).

The resulting combination of components was then pressed into a thin composite film using a double belt press set up at a temperature of 320-330° C. and pressure of 1-3 MPa. The film was heated for approximately 10 minutes. The polymer melted and impregnated the fabric fibers. The composition and properties of the composite films are reported in the Results section below.

Method of preparation of the copper-clad laminates (CCL): copper clad laminates with the following configuration copper/composite film (CF)/copper were obtained by laminating the composite films between two T49A-DS-HD2-12 copper foils (manufactured by Fukuda) in a Lauffer laminator at 340° C. for 20 minutes under a pressure of 3 MPa.

### Test Methods

Dielectric Performances (Dₖ, D_{f})

The dielectric constant Dₖ and the dissipation factor D_{f} were measured at 5 GHz by Split Post Dielectric Resonator (SPDR), according to IEC 61189-2-721:2015 after drying 1 h at 100° C. and after immersion in water for 24 hours.

The dielectric constant Dk and the dissipation factor Df were measured at 20 GHz by Split Cylinder Resonator, according to IPC TM-650 2.5.5.13 after drying 1 h at 100° C. and after immersion in water for 24 hours.

### MIT Flex Endurance Test (A)

MIT Flex endurance test was performed according to ASTM D2176-16 using a MIT folding endurance tester at 90 cycles/min under a 0.9072 Kg load, 135° angle and a temperature of at 23±2° C. Details about the tester are given in ASTM D2176-16 (reapproved 2021).

The tester of Tinius Olsen (see https://www.tiniusolsen.com/product/mit-folding-endurance-tester/) can be used.

### MIT Flex Endurance Test (B)

The MIT bending test was performed according to IPC TM-650 2.4.3 to evaluate the flexibility of the composite films (CF) and of the CCL. Test conditions: 0.6 mm bending radius, 40 cycles/minute bending frequency, 0-180° bending angle.

### Tensile Strength

Tensile test was measured using an Instron® mechanical test machine according to ASTM D882.

### Coefficient of Thermal Expansion (CTE)

CTE was measured in tension mode pursuant to ASTM D696-16. During the test, the first heating goes from 23° C. to 250° C. at 5° C./min; the first cooling goes from 250° C. to 23° C. at 5° C./min; the second heating goes from 23° C. to 210° C. at 5° C./min. The CTE is measured from the dimensional change during the second heating.

### Volume of Fibers

Volume of fibers (Vf) is calculated according to the following equation:

$${V}_{f} = \frac{Volume of fiber}{Volume of fiber + Volume of polymer}$$

### Peeling Force

The peeling force with copper foil was measured according to IPC-TM-650.2.4.9.

### Results

TABLE I

| | Film #1 |
|---|---|
| components and | FP-1 / FF-1 / FP-1 |
| configuration of the CF | |
| Vf | 46% |
| Thickness (mm) | 0.042 |
| Dk 5 GHz after drying 1 h at | 2.6 |
| 100° C. | |
| Df 5 GHz after drying 1 h at | 0.0012 |
| 100° C. | |
| Dk 5 GHz after 1 day at RT | 2.6 |
| 50% RH | |
| Df 5 GHz after 1 day at RT | 0.0011 |
| 50% RH | |
| Dk 5 GHz after immersion in | 2.6 |
| water for 24 h | |
| Df 5 GHz after immersion in | 0.0010 |
| water for 24 h | |
| Dk 20 GHz after drying 1 h at | 2.6 |
| 100° C. | |
| Df 20 GHz after drying 1 h at | 0.0022 |
| 100° C. | |
| Dk 20 GHz after 1 day at RT | 2.6 |
| 50% RH | |
| Df 20 GHz after 1 day at RT | 0.0022 |
| 50% RH | |
| Dk 20 GHz after immersion | 2.6 |
| in water for 24 h | |
| Df 20 GHz after immersion | 0.0023 |
| in water for 24 h | |
| Peeling force with copper foil | >>10N/cm |
| MIT bending test ASTM | >90,000 |
| D2176-16 | |

* The peeling force was measured for the adhesion between copper foil and composite film.

TABLE II

| | Film #2 |
|---|---|
| components and | FP-1 / FF-1 / FP-1 |
| configuration of the CF | |
| Vf | 51% |
| Thickness (mm) | 0.048 |
| Dk 5 GHz after drying 1 h at | 2.4 |
| 105° C. | |
| Df 5 GHz after drying 1 h at | 0.0012 |
| 105° C. | |
| Dk 5 GHz after 1 day at RT | 2.5 |
| 50% RH | |
| Df 5 GHz after 1 day at RT | 0.0012 |
| 50% RH | |
| Dk 5 GHz after immersion in | 2.4 |
| water for 24 h | |
| Df 5 GHz after immersion in | 0.0011 |
| water for 24 h | |
| Dk 20 GHz after drying 1 h at | 2.4 |
| 100° C. | |
| Df 20 GHz after drying 1 h at | 0.0021 |
| 100° C. | |
| Dk 20 GHz after 1 day at RT | 2.4 |
| 50% RH | |
| Df 20 GHz after 1 day at RT | 0.0021 |
| 50% RH | |
| Dk 20 GHz after immersion | 2.4 |
| in water for 24 h | |
| Df 20 GHz after immersion | 0.0021 |
| in water for 24 h | |

TABLE III

| | Film #3 |
|---|---|
| components and | FP-1 / FF-1 / FP-1 |
| configuration of the CF | |
| Vf | 36% |
| Thickness (mm) | 0.055 |
| Dk 5 GHz after drying 1 h at | 2.4 |
| 105° C. | |
| Df 5 GHz after drying 1 h at | 0.0010 |
| 105° C. | |
| Dk 5 GHz after 1 day at RT | 2.4 |
| 50% RH | |
| Df 5 GHz after 1 day at RT | 0.0011 |
| 50% RH | |
| Dk 5 GHz after immersion in | 2.4 |
| water for 24 h | |
| Df 5 GHz after immersion in | 0.0010 |
| water for 24 h | |
| Dk 20 GHz after drying 1 h at | 2.5 |
| 100° C. | |
| Df 20 GHz after drying 1 h at | 0.0018 |
| 100° C. | |
| Dk 20 GHz after 1 day at RT | 2.5 |
| 50% RH | |
| Df 20 GHz after 1 day at RT | 0.0017 |
| 50% RH | |
| Dk 20 GHz after immersion | 2.5 |
| in water for 24 h | |
| Df 20 GHz after immersion | 0.0017 |
| in water for 24 h | |
| Peeling force with copper foil | >>10N/cm |

TABLE IV

| | Film #4 |
|---|---|
| components and | FP-1 / FF-1 / FP-1 |
| configuration of the CF | |
| Vf | 22% |
| Thickness (mm) | 0.087 |
| Dk 5 GHz after drying 1 h at | 2.3 |
| 105° C. | |
| Df 5 GHz after drying 1 h at | 0.0010 |
| 105° C. | |
| Dk 5 GHz after 1 day at RT | 2.4 |
| 50% RH | |
| Df 5 GHz after 1 day at RT | 0.0010 |
| 50% RH | |
| Dk 5 GHz after immersion in | 2.3 |
| water for 24 h | |
| Df 5 GHz after immersion in | 0.0010 |
| water for 24 h | |
| Dk 20 GHz after drying 1 h at | 2.4 |
| 100° C. | |
| Df 20 GHz after drying 1 h at | 0.0015 |
| 100° C. | |
| Dk 20 GHz after 1 day at RT | 2.4 |
| 50% RH | |
| Df 20 GHz after 1 day at RT | 0.0014 |
| 50% RH | |
| Dk 20 GHz after immersion | 2.4 |
| in water for 24 h | |
| Df 20 GHz after immersion | 0.0016 |
| in water for 24 h | |

TABLE V

| | Film #5 |
|---|---|
| components and | FP-1 / FF-2 / FP-1 |
| configuration of the CF | |
| Vf | |
| Thickness (mm) | 0.062 |
| Dk 5 GHz after drying 1 h at | 2.2 |
| 100° C. | |
| Df 5 GHz after drying 1 h at | 0.0006 |
| 100° C. | |
| Dk 5 GHz after 1 day at RT | 2.2 |
| 50% RH | |
| Df 5 GHz after 1 day at RT | 0.0009 |
| 50% RH | |
| Dk 20 GHz after drying 1 h at | 2.2 |
| 100° C. | |
| Df 20 GHz after drying 1 h at | 0.0012 |
| 100° C. | |
| Dk 20 GHz after 1 day at RT | 2.2 |
| 50% RH | |
| Df 20 GHz after 1 day at RT | 0.0012 |
| 50% RH | |

TABLE VI

| | Film #6 |
|---|---|
| components and | FP-1 / FF-2 / FP-1 |
| configuration of the CF | |
| Vf | |
| Thickness (mm) | 0.090 |
| Dk 5 GHz after drying 1 h at | 2.2 |
| 100° C. | |
| Df 5 GHz after drying 1 h at | 0.0007 |
| 100° C. | |
| Dk 5 GHz after 1 day at RT | 2.2 |
| 50% RH | |
| Df 5 GHz after 1 day at RT | 0.0012 |
| 50% RH | |
| Dk 20 GHz after drying 1 h at | 2.2 |
| 100° C. | |
| Df 20 GHz after drying 1 h at | 0.0009 |
| 100° C. | |
| Dk 20 GHz after 1 day at RT | 2.2 |
| 50% RH | |
| Df 20 GHz after 1 day at RT | 0.0010 |
| 50% RH | |

TABLE VII

| | Film #7 |
|---|---|
| components and | FP-2 / FF-1 / FP-2 |
| configuration of the CF | |
| Vf | 53% |
| Thickness (mm) | 0.050 |
| Dk 5 GHz after drying 1 h at | 2.5 |
| 100° C. | |
| Df 5 GHz after drying 1 h at | 0.0010 |
| 100° C. | |
| Dk 5 GHz after 1 day at RT | 2.5 |
| 50% RH | |
| Df 5 GHz after 1 day at RT | 0.0011 |
| 50% RH | |
| Dk 5 GHz after immersion in | 2.5 |
| water for 24 h | |
| Df 5 GHz after immersion in | 0.0030 |
| water for 24 h | |
| Dk 20 GHz after drying 1 h at | 2.6 |
| 100° C. | |
| Df 20 GHz after drying 1 h at | 0.0022 |
| 100° C. | |
| Dk 20 GHz after 1 day at RT | 2.6 |
| 50% RH | |
| Df 20 GHz after 1 day at RT | 0.0022 |
| 50% RH | |
| Dk 20 GHz after immersion | 2.6 |
| in water for 24 h | |
| Df 20 GHz after immersion | 0.0022 |
| in water for 24 h | |
| Peeling force with copper | 18N/cm |
| foil* | |

TABLE VIII

| | Film # 8 |
|---|---|
| Components | LCP film Vecstar ® CTQ-100 |
| Thickness (mm) | 0.100 |
| Dk 5 GHz after drying 1 h at | 3.3 |
| 105° C. | |
| Df 5 GHz after drying 1 h at | 0.0015 |
| 105° C. | |
| Dk 5 GHz after 1 day at RT | 3.3 |
| 50% RH | |
| Df 5 GHz after 1 day at RT | 0.0016 |
| 50% RH | |
| Dk 5 GHz after immersion in | 3.3 |
| water for 24 h | |
| Df 5 GHz after immersion in | 0.0016 |
| water for 24 h | |
| Dk 20 GHz after drying 1 h at | 3.4 |
| 100° C. | |
| Df 20 GHz after drying 1 h at | 0.0017 |
| 100° C. | |
| Dk 20 GHz after 1 day at RT | 3.4 |
| 50% RH | |
| Df 20 GHz after 1 day at RT | 0.0018 |
| 50% RH | |
| Dk 20 GHz after immersion | 3.4 |
| in water for 24 h | |
| Df 20 GHz after immersion | 0.0018 |
| in water for 24 h | |
| Peeling force with copper | 4N/cm |
| foil* | |
| MIT bending test ASTM | 8200 |
| D2176-16 | |

Composite films of #1-#5 have a much higher adhesion strength to the copper foil in comparison with the comparative LCP film #8. Composite films #1-#5 have a high folding resistance, as a strong indication of its high flexibility, compared with the comparative LCP film of film #8.

Composite films CF of #1 #7 have very good dielectric properties at all conditions.

Table IX illustrates also the invention with other composite films (CF). The composite film (CF) of the invention (see CF #9 and CF #10) exhibit a CTE in MD or in TD lower than or equal to 80 ppm (1 ppm/° C.=μm/(m.° C.)).

All examples composite films #1-#10 are with angle α=0°.

TABLE IX

| | Composite film #9 | | Composite film #10 | |
|---|---|---|---|---|
| Components | FP-1/FF-3/FP-1 | | FP-1/FF-3/FP-1 | |
| Vf | 36% | | 36% | |
| Thickness (T) | 0.06 | mm | 0.09 | mm |
| Dielectric loss, Df @ 5 | 0.0006 | | 0.0007 | |
| GHz, dry | | | | |
| Dielectric loss, Df @ 5 | 0.0009 | | 0.0012 | |
| GHz, 50% RH | | | | |
| Dielectric constant, Dk @ | 2.2 | | 2.2 | |
| 5 GHz, 50% RH | | | | |
| Dielectric loss, Df @ 20 | 0.0012 | | 0.0010 | |
| GHz, 50% RH | | | | |
| CTE, MD | 54 | ppm / ° C. | 70 | ppm / ° C. |
| CTE, TD | 17 | ppm / ° C. | 45 | ppm / ° C. |
| Peeling force with copper | 1 | kg/cm | 0.9 | kg/cm |

foil

MD: means machine direction;
TD: means transverse direction

In Table X, one can find the influence of angle α (see embodiment (E3)) on the bendability of the composite film (CF) alone or of the CCL:
for CF: one can see a dramatic increase of the test with a number of cycles before failure increasing from 720 (α=0°) to 11525 (α=45°);
for CCL: the same effect is visible whether the CCL is single sided or doubled sided.

These results with α between 20° and 80°, preferably between 30° and 70°, preferably between 40° and 60°, preferably between 42° and 58° or between 44° and 46° illustrate the improved bendability of the CF.

TABLE X

| | | | | | bending |
|---|---|---|---|---|---|
| | CF or CCL** (film laminated with copper foil) | | | | cycles before |
| | Film of the | | | | failure - |
| | composition | | | | bending |
| Ex. | (C) | FF | angle α in ° | Cu | test (B) |
| CF | 13 μm thick | FF-1 | 0 | ∘∘ | 720 |
| CF | 13 μm thick | FF-1 | 45 | ∘∘ | 11525 |
| CCL | 18 μm thick | FF-3 | 0 | single side | 1740 |
| CCL | 18 μm thick | FF-3 | 45 | single side | 17152 |
| CCL | 18 μm thick | FF-3 | 0 | double side | 1341 |
| CCL | 18 μm thick | FF-3 | 45 | double side | 14044 |
| CCL | 26 μm thick | FF-3 | 0 | double side | 1162 |
| CCL | 26 μm thick | FF-3 | 45 | double side | 15331 |
| CCL | 18 μm thick | FF-4 | 0 | double side | 7022 |
| CCL | 18 μm thick | FF-4 | 45 | double side | 41826 |
| CCL | 26 μm thick | FF-4 | 0 | single side | 2730 |
| CCL | 26 μm thick | FF-4 | 45 | single side | 19597 |
| CCL | 26 μm thick | FF-4 | 0 | double side | 2030 |
| CCL | 26 μm thick | FF-4 | 45 | double side | 15668 |

∘∘: configuration (ii) [composition (C) layer] / fiber fabric (FF) / [composition (C) layer]
single side = [Cu layer] / [composition (C) layer] / fiber fabric (FF) / [composition (C) layer]
double side = [Cu layer] / [composition (C) layer] / fiber fabric (FF) / [composition (C) layer] / [Cu layer]
composition (C) = 100% of FP-1

1. A composite film (CF) having a thickness (T) of less than 0.20 mm, and comprising:
a fiber fabric (FF) selected from the group of glass or quartz fiber fabric; and
a composition (C) comprising at least one fluoropolymer (FP) coated on a surface of the fiber fabric (FF);
wherein the fiber fabric (FF) is woven and wherein the fluoropolymer (FP) comprises:
recurring units derived from tetrafluoroethylene (R_{TFE});
recurring units (R_{F}) derived from a fluoromonomer (F) selected from the group of perfluoro(alkyl vinyl ether)s (PAVE), hexafluoropropylene (HFP) and combination of two or more of said fluoromonomers; and
recurring units (R_{M}) derived from at least one monomer (M) selected from the group consisting of (i) monomers comprising a functional group (FG) selected from the group consisting of an hydroxy group, an isocyanate group, a carboxylic acid group and an anhydride group, (ii) chlorotrifluoroethylene (CTFE) and (iii) dichlorodifluoroethylene (R1112); and
with the following proportions expressed in mol %:
(R_{TFE}): at least 75.0 mol %;
(R_{F}): between 0 and 20.0 mol %; and
(R_{M}): between 0.01 to 5.0 mol %;
these proportions in mol % being based on a total amount of moles of recurring units of the fluoropolymer (FP).

2. A composite film (CF) having a thickness (T) of less than 0.20 mm, and comprising or consisting of, in that order:
a layer (L1) of a composition (C);
a fiber fabric (FF) selected from the group of glass fiber fabric or quartz fiber fabric; and
a layer (L2) of composition (C);
wherein composition (C) comprises at least one fluoropolymer (FP) in contact with at least one surface of the fiber fabric (FF); and
wherein the fiber fabric (FF) is woven and wherein the fluoropolymer (FP) comprises:
recurring units derived from tetrafluoroethylene (R_{TFE});
recurring units (R_{F}) derived from a fluoromonomer (F) selected from the group of perfluoro(alkyl vinyl ether)s (PAVE), hexafluoropropylene (HFP) and combination of two or more of said fluoromonomers; and
recurring units (R_{M}) derived from at least one monomer (M) selected from the group consisting of (i) monomers comprising a functional group (FG) selected from the group consisting of an hydroxy group, an isocyanate group, a carboxylic acid group and an anhydride group, (ii) chlorotrifluoroethylene (CTFE) and (iii) dichlorodifluoroethylene (R1112); and
with the following proportions expressed in mol %:
(R_{TFE}): at least 75.0 mol %;
(R_{F}): between 0 and 20.0 mol %; and
(R_{M}): between 0.01 and 5.0 mol %;
these proportions in mol % being based on a total amount of moles of recurring units of the fluoropolymer (FP).

3. (canceled)

4. The composite film (CF) according to claim 1, wherein the proportion of recurring units (R_{M}) in the fluoropolymer (FP) is:
between 0.05 and 5.0 mol % or between 0.05 and 3.0 mol %; and/or
at most 1.5 mol % or at most 1.0 mol %.

5-7. (canceled)

8. The composite film (CF) according to claim 1, wherein the fluoromonomer (F) is selected from the group of perfluoro(alkyl vinyl ether)s (PAVE) of generic formula CF₂═CFOR_{f} (I) wherein R_{f} is a C₁-C₈ perfluoroalkyl group.

9. The composite film (CF) according to claim 1, wherein monomer (M) is selected from the group consisting of CTFE, R1112, itaconic anhydride, citraconic anhydride and 5-norbornene-2,3-dicarboxylic anhydride (NAH).

10. The composite film (CF) according to claim 1, wherein the fluoropolymer (FP) is a copolymer comprising recurring units from TFE, at least one perfluoro (alkyl vinyl ether) (PAVE) and at least one monomer (M) comprising an anhydride group, with the following proportions:
(R_{TFE}): at least 95.5 mol %;
(R_{PAVE}): between 1.0 and 3.0 mol %;
(R_{M}): between 0.08 and 1.5 mol %.

11. The composite film (CF) according to claim 1, wherein a melting temperature (Tm) of the fluoropolymer (FP) is at least 280° C.

12. The composite film (CF) according to claim 1, wherein melt flow rate (MFR) of the fluoropolymer (FP) measured according to ASTM D1238 (372° C.; 5 kg) is at least 1.0 g/10 min.

13-16. (canceled)

17. The composite film (CF) according to claim 1, wherein the fiber fabric (FF) has an average area weight (in grams per square meter or g/m²) comprised between 10 g/m² and 100 g/m².

18. The composite film (CF) according to claim 1, exhibiting at least one of the following dielectric constant Dk at 5 GHz as measured by Split Post Dielectric Resonator (SPDR), IEC 61189-2-721:2015:

| | |
|---|---|
| after drying 1 h at 100° C. | equal to or less than 3.0 |

and/or

| | |
|---|---|
| after immersion in water for | equal to or less than 3.0 |
| 24 hours | |

and/or

| | |
|---|---|
| after leaving the film 1 day at | equal to or less than 3.0 |
| room temperature in an | |
| atmosphere with 50% | |
| relative humidity | |

19. The composite film (CF) according to claim 1, exhibiting at least one of the dissipation factors Df at 5 GHz as measured by Split Post Dielectric Resonator (SPDR), IEC 61189-2-721:2015:

| | |
|---|---|
| after drying 1 h at 100° C. | equal to or less than 0.0020 |

and/or

| | |
|---|---|
| after immersion in water for | equal to or less than 0.0020 |
| 24 hours | |

and/or

| | |
|---|---|
| after leaving the film 1 day at | equal to or less than 0.0020 |
| room temperature in an | |
| atmosphere with 50% | |
| relative humidity | |

20. The composite film (CF) according to claim 1, exhibiting at least one of the following dielectric constants Dk at 20 GHz as measured by Split Cylinder Resonator, IPC TM-650 2.5.5.13:

| | |
|---|---|
| after drying 1 h at 100° C. | equal to or less than 3.0 |

and/or

| | |
|---|---|
| after immersion in water for | equal to or less than 3.0 |
| 24 hours | |

and/or

| | |
|---|---|
| after leaving the film 1 day at | equal to or less than 3.0 |
| room temperature in an | |
| atmosphere with 50% | |
| relative humidity | |

21. The composite film (CF) according to claim 1, exhibiting at least one of the following dissipation factors Df at 20 GHz as measured by Split Cylinder Resonator, IPC TM-650 2.5.5.13:

| | |
|---|---|
| after drying 1 h at 100° C. | equal to or less than 0.0030 |

and/or

| | |
|---|---|
| after immersion in water for | equal to or less than 0.0028 |
| 24 hours | |

and/or

| | |
|---|---|
| after leaving the film 1 day at | equal to or less than 0.0028 |
| room temperature in an | |
| atmosphere with 50% | |
| relative humidity | |

22. (canceled)

23. The composite film according to claim 1, exhibiting a folding endurance equal to or greater than 40,000 cycles, measured according to ASTM D2176-16 at 90 cycles/min under a 0.9072 Kg load, 135° angle and a temperature of at 23±2° C.

24. The composite film according to claim 1, exhibiting a coefficient of thermal expansion (CTE), in MD or in TD, lower than or equal to 80 ppm/° C. (1 ppm=μm/(m.° C.)).

25. The composite film according to claim 1, where warp (f1) or weft fibers (f2) of the fiber fabric (FF) are oriented at an angle α relative to the longitudinal axis of the composite film (CF), α being between 20° and 80°.

26. The composite film according to claim 1, wherein the composite film (CF) is according to (i) configuration (composition (C))/fiber fabric (FF)) or (ii) configuration (composition (C))/fiber fabric (FF))/(composition (C)).

27-28. (canceled)

29. The composite film according to claim 1, wherein the composite film (CF) is prepared by a method which comprises a) putting into contact the composition (C) on the surface(s) of the fiber fabric (FF) and b) applying pressure and heat to a composite structure obtained after step a).

30. The composite film according to claim 1, wherein the composite film (CF) is prepared by a method which comprises the steps of a) putting into contact the composition (C) comprising the fluoropolymer (FP) on the fiber fabric (FF) and b) applying pressure P of at least 0.3 MPa and heating at a temperature T_{process} such that the composition (C) is in a molten form.

31. (canceled)

32. Copper-clad laminate (CCL) comprising at least one copper foil and the composite film (CF) according to claim 1.

33. Copper-clad laminate (CCL) according to claim 32, having a configuration (in that order): copper foil/composite film (CF) or a configuration: copper foil/composite film (CF)/copper foil.

34-35. (canceled)
